(19) United States
(12) Patent Application Publication
(10) Pub. No.: US 2024/0419480 A1
(43) Pub. Date: Dec. 19, 2024

(54) INFORMATION PROCESSING SYSTEM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: Liu LIU, Fuchu Tokyo (JP); Masahide ONO, Fuchu Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/820,737

(22) Filed: Aug. 30, 2024

Related U.S. Application Data
(63) Continuation of application No. PCT/JP2022/046848, filed on Dec. 20, 2022.

(30) Foreign Application Priority Data
Mar. 2, 2022 (JP) 2022-032105

(51) Int. Cl. G06F 9/455

(52) U.S. Cl. CPC G06F 9/45558; G06F 2009/45591; G06F 2009/45595

(57) ABSTRACT

An information processing system configured to create and debug a control program executed in a control device, the information processing system includes at least one server device and a plurality of client devices. The at least one server device is configured to operate in a cloud environment to which a plurality of client devices are connected via a network; configure a virtual machine in the cloud environment; virtually configure the control device as a virtual control device in the virtual machine; compile the control program; and execute the control program in the virtual control device. The plurality of client devices is configured to transmit a request for compiling the control program in the virtual machine to the server device; and transmit a request for executing content of the control program in the virtual control device to the server device.

### CROSS REFERENCE TO THE RELATED APPLICATIONS

This application is continuation application of International Application No. JP2022/046848, filed on Dec. 20, 2022, which claims priority to Japanese Patent Application No. 2022-032105, filed on Mar. 2, 2022, the entire contents of which are incorporated herein by reference.

### FIELD

Embodiments of the present invention relate to an information processing system.

### BACKGROUND

Plant control devices are controlled by control programs described by programmers using graphical languages such as a ladder diagram (LD), a function block diagram (FBD), and a sequential function chart (SFC) defined by the international standard IEC 61131-3, or text languages such as an instruction list (IL) and structured text (ST). The programmers create programs for automatically operating plants in control program creation devices using the above languages and provide the programs to plant operators. The programmers perform debugging by a unit test, a coupling test, and the like, and further execute debugging of the control programs at the time of adjustment on plant sites.

To perform debugging, the programmers confirm operations of the control programs by replacing units of the control programs or forcibly changing contact points or values of variables in an online state. There is a demand for an environment in which anyone can create and debug programs and use the programs anytime and anywhere such that there is no limitation to the programmers in terms of time and place.

However, in the program creation and debugging as described above, a debugging environment using a stationary PC, an actual control machine, a simulator, or an emulator is required to verify a control program. Since a control device and a system development environment are fixed, work is actually limited by time and place even when the simulator or the like is used.

### BRIEF DESCRIPTION OF DRAWINGS

FIG. 1 is a diagram illustrating an example of a configuration of an information processing system according to one embodiment.

FIG. 2 is a diagram illustrating an example of a configuration of a client device and a control device according to the embodiment.

FIG. 3 is a diagram illustrating an example of a configuration of the information processing system according to the embodiment.

FIG. 4 is a diagram illustrating an example of a graphically drawn control program according to the embodiment.

FIG. 5 is a diagram schematically illustrating an example of the information processing system according to the embodiment.

FIG. 6 is a flowchart illustrating an example of processing of the information processing system according to the embodiment.

FIG. 7 is a diagram schematically illustrating an example of an information processing system according to one embodiment.

FIG. 8 is a flowchart illustrating an example of processing of the information processing system according to the embodiment.

FIG. 9 is a diagram schematically illustrating an example of an information processing system according to one embodiment.

FIG. 10 is a diagram illustrating an example of a configuration of a control system according to one embodiment.

### DETAILED DESCRIPTION

According to one embodiment, an information processing system includes at least one server device and a plurality of client devices, and creates and debugs a control program executed in a control device. The server device operates in a cloud environment to which the plurality of client devices are connected via a network, configures a virtual machine in the cloud environment, virtually configures the control device as a virtual control device in the virtual machine, compiles the control program, and causes the virtual control device to execute the control program. The client device transmits a request for compiling the control program in the virtual machine to the server device, and transmits a request for executing content of the control program in the virtual control device to the server device.

Hereinafter, embodiments will be described with reference to the drawings.

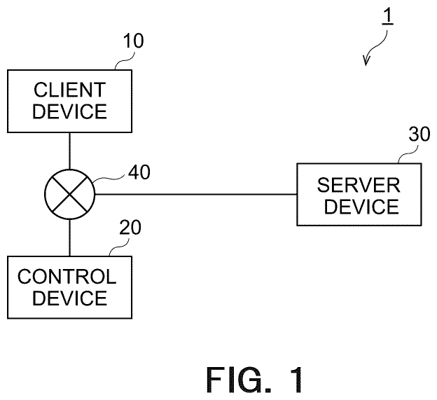

FIG. 1 is a diagram schematically illustrating an example of an information processing system according to one embodiment. An information processing system 1 includes a client device 10, a control device 20, a server device 30, and a network 40. Note that the information processing system 1 does not necessarily include the control device 20, and may include at least the client device 10 and the server device 30 which are connected via the network 40.

The client device 10 is a device that creates a control program and transmits the compiled control program to the control device 20. The client device 10 includes an interface that enables input and output of data from and to a user.

The control device 20 is a device that controls a plant. The control device 20 controls the plant using the compiled control program received from the client device 10.

Although FIG. 1 illustrates one client device 10 and one control device 20, but this is illustrated as a non-limiting example. One or a plurality of client devices 10 and one or a plurality of control devices 20 may be provided for at least one server device 30.

In the present disclosure, the server device 30 constructs a virtual machine environment on a cloud, and enables the client device 10 to access the virtual machine environment. In this virtual machine environment, the server device 30 executes creation and debugging of a control program in response to a request from the client device 10.

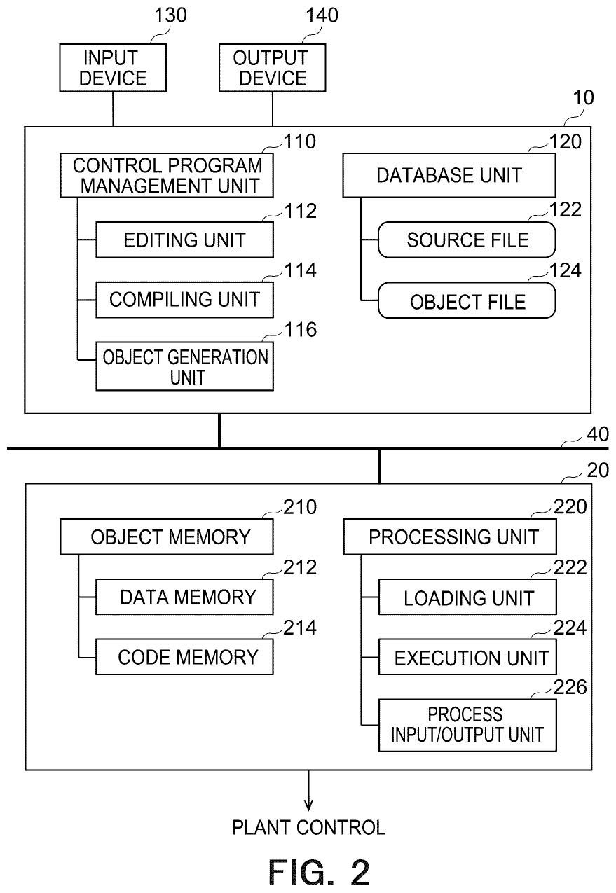

FIG. 2 is a block diagram schematically illustrating a non-limiting example of the client device 10 and the control device 20. Note that one client device 10 and one control device 20 are illustrated in this drawing, but are not limited thereto, and a configuration in which one or a plurality of client devices 10 and one or a plurality of control devices 20 are connected may be adopted.

The client device 10 includes, for example, a control program management unit 110 and a database unit 120. In addition, the client device 10 is connected to an input device 130 and an output device 140 via an input/output interface, or includes the input device 130 and the output device 140.

The control program management unit 110 manages editing of a control program (including creation of a new control program) by a programmer. The control program management unit 110 includes an editing unit 112, a compiling unit 114, and an object generation unit 116.

When the user edits a program via the input device 130, the editing unit 112 performs processing of reflecting the editing in the client device 10. The editing unit 112 provides, for example, a graphical user interface (GUI) through which the programmer graphically edits the program, and receives an editing request from the programmer. When the programmer edits the program via the GUI, the editing unit 112 can also cause the edited program to be reflected and displayed on the GUI.

The editing unit 112 may register a backup of the program in a database at any timing requested by the programmer or at any time interval such as a predetermined time interval. That is, the client device 10 may automatically or manually back up a source file being edited. The source file may be registered in the database as different files in the case of automatic backup and the case of manual backup.

The compiling unit 114 checks the grammar in the source file. The object generation unit 116 converts the source file of a control program into an object file. Note that these processes may be combined, and for example, the compiling unit 114 may create the object file, which is a binary file, following the grammar check of the program.

The database unit 120 registers a source file 122 and an object file 124. These files may be registered in association with each other. More specifically, the database unit 120 registers the source file 122 of a control program edited and created by the editing unit 112 and the object file 124 of the control program generated by the compiling unit 114 and the object generation unit 116.

The input device 130 is a device that receives an input from the user in the client device 10. The input device 130 is, for example, a mouse, a keyboard, a trackball, a touch panel, or the like, but is not limited thereto, and may be any device that appropriately receives an input from the user.

The output device 140 is a device that outputs information to the user in the client device 10. The output device 140 is, for example, a display device such as a display or a printing device such as a printer, but is not limited thereto, and may be any device that appropriately outputs information to the user. The client device 10 outputs various types of information to the user via the output device 140.

In this configuration, the client device 10 converts an edited program into an object file in an execution file format, and downloads the object file to the control device 20 via the network 40, thereby enabling the control of the plant by the control device 20.

The control device 20 includes an object memory 210 and a processing unit 220. As described above, the control device 20 downloads the object file from the client device 10 and executes the downloaded file to control the plant.

The object memory 210 is a memory that stores information on an object of the control program. The object memory 210 includes a data memory 212 and a code memory 214.

The data memory 212 is an area in which the object file downloaded from the client device 10 is expanded. The control device 20 controls the plant by referring to the object file expanded in the data memory 212.

The code memory 214 downloads and stores a source code corresponding to the program expanded in the data memory 212. Note that the code memory 214 is not an essential configuration in the control device 20, and is an optional configuration.

The processing unit 220 executes writing and reading of information stored in the object memory 210 and executes the plant control. The processing unit 220 includes a loading unit 222, an execution unit 224, and a process input/output unit 226.

The loading unit 222 deploys an object program of the control program transmitted via the network in the data memory 212 and the code memory 214.

The execution unit 224 executes the appropriately deployed object program and performs control on the plant based on the control program.

The process input/output unit 226 notifies the control program of a process signal from the plant. The process input/output unit 226 notifies the execution unit 224 of information received from the plant, whereby the execution unit 224 can execute appropriate control according to a situation of the plant.

With such configurations of the client device 10 and the control device 20, the user can implement the plant control via the client device 10. The client device 10 and the control device 20 only need to be connected via the network 40, and it may be configured such that, for example, the control device 20 is disposed in a factory in which the plant is disposed and the client device 10 is be provided in a place different from the factory.

In a project for controlling the plant, a control program may be created and edited by a plurality of programmers. Thus, not one but a plurality of client devices 10 may be provided. Similarly, there may be a plurality of control devices 20 that can be controlled from the client device 10.

In a case where a plurality of users control the same program in this manner, normally, debugging is executed in the client devices 10 operated by the programmers, respectively. In the control program in the plant control, it is desirable to adopt a configuration in which each of the programmers can edit the control program in the client device 10 connected remotely.

In the present disclosure, an implementation that enables editing and debugging from the plurality of client devices 10 is constructed based on the information processing system 1 illustrated in FIG. 1.

### First Embodiment

In one embodiment, the server device 30 enables execution of some functions of the client device 10 described above.

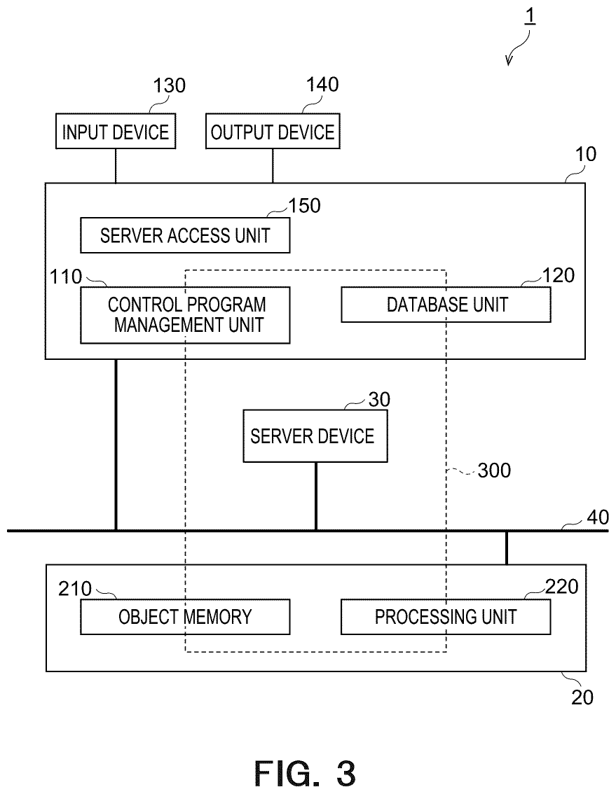

FIG. 3 is a diagram illustrating the information processing system 1 according to the embodiment in more detail than FIG. 1. As described above, the client device 10 and the control device 20 are connected to the server device 30 via the network 40. In the present embodiment, it is not essential that the client device 10 and the server device 30 be connected to the control device 20 via the network 40.

The server device 30 constructs a virtual machine 300 connectable from at least the client device 10 on a cloud. As indicated by a dotted line, some or all of functions of the control program management unit 110 and the database unit 120 of the client device 10, and the object memory 210 and the processing unit 220 of the control device 20 are constructed in the virtual machine 300.

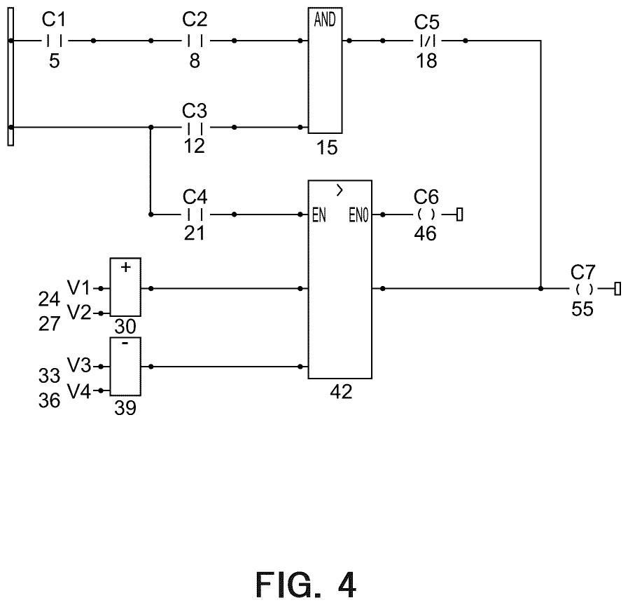

FIG. 4 is a diagram illustrating an example of a graphical display of a control program edited by a user via the editing unit 112. The editing unit 112 has, for example, a configuration in which the user can create the LD language and the like defined by IEC 61131-3 in graphic language. Specifically, the editing unit 112 may display an image illustrated in FIG. 4 on a display device which is the output device 140.

A programmer views the display device and operates the input device 130 to add, delete, and move a component image according to a program language to describe the control program. For example, C1 to C7 correspond to commands described in graphic language. The editing unit 112 creates and edits the control program in response to a request from the user. In this manner, the user edits the control program via the editing unit 112.

In the present embodiment, such editing of the control program is executed on the virtual machine 300.

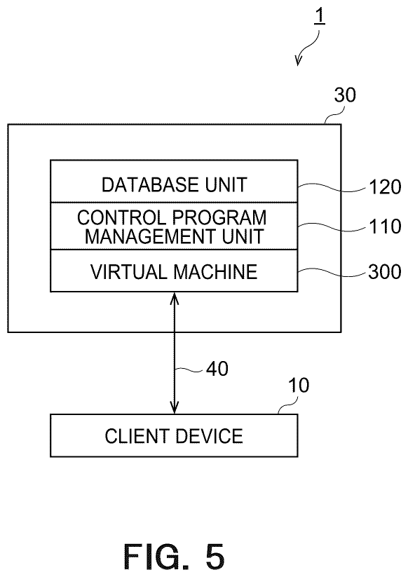

FIG. 5 is a diagram schematically illustrating the information processing system 1 according to the present embodiment. The server device 30 constructs the virtual machine 300 on the cloud. In the virtual machine 300, the control program management unit 110 (including the GUI) and the database unit 120 of the client device 10 are virtually constructed.

The client device 10 accesses the virtual machine 300 built on the cloud via the network 40. This access method may be executed via the server access unit 150 in FIG. 3. As described above, the server access unit 150 may be connected using a remote desktop function as an example. As another example, the server access unit 150 may access the virtual machine 300 via an application such as a browser.

The user edits the graphically described control program, output from the control program management unit 110 constructed on the virtual machine 300, via the client device 10. The virtual control program management unit 110 registers the edited control program in the virtual database unit 120.

The virtual machine 300 may perform control in which the control program is edited by only one user. As a more limiting example, the virtual machine 300 may limit the number of users who can access the control program management unit 110 on the virtual machine 300 to one such that the number of users who can perform editing at the same time is one.

The server device 30 may start a predetermined operating system (OS), for example, Linux (registered trademark), Windows (registered trademark), or the like, as the virtual machine 300.

In a case where another user accesses during access by a certain user, the virtual machine 300 may block access to the virtual control program management unit 110 and the database unit 120, or may permit only browsing.

In addition, the server device 30 may restrict the access to the virtual machine 300 so as to allow access of only a user permitted by an access restriction method such as an ID and a password.

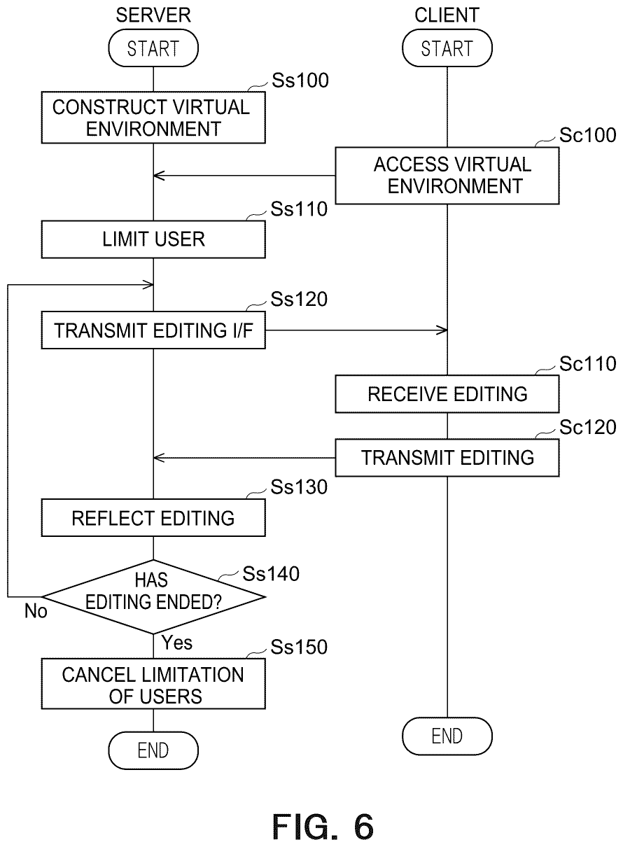

FIG. 6 is a flowchart illustrating an outline of processing of the information processing system 1 according to the embodiment.

First, the server device 30 constructs the virtual machine 300 that is a virtual environment (Ss100). As illustrated in FIG. 5, for example, the control program management unit 110 and the database unit 120 may be formed in the virtual environment. An editing interface for editing a control program is also configured at this stage.

Note that the construction of the virtual environment may be executed in response to a request from the client device 10. That is, the request for constructing the virtual environment may be received from the client device 10 before the process of Ss100.

In this state, the client device 10 accesses the virtual environment via the server access unit 150 based on a request from a user (Sc100).

The server device 30 may limit users so as to permit the access of the user when the accessing user is a permitted user and prevent access of another user (Ss100). As described above, only editing may be possible by one user, and browsing may be possible. This access control may be performed by a general method.

The server device 30 transmits, to the client device 10, an editing interface related to an appropriate portion of the constructed virtual environment, for example, the editing unit 112 of the control program management unit 110 (Ss120).

The client device 10 receives editing of the control program from the user using the received editing interface (Sc110).

The client device 10 transmits the editing to the server device 30 at any timing (Sc120). The transmitted information on the control program may be backed up in a storage unit provided on the cloud by the server device 30 at any timing.

The server device 30 reflects the editing received from the client device 10 at least in the editing interface (Ss130). At this timing, the server device 30 may back up an edited source code. Note that this backup may also be reflected in the client device 10 at any timing.

When the editing has not ended (Ss140: No), the server device 30 may transmit an interface reflecting the editing to the client device 10, and the information processing system 1 repeats the processes of Ss120 to Ss130 and Sc110 to Ss120.

When it is determined that the editing has ended (Ss140: Yes), the server device 30 cancels the limitation of users (Ss150), and ends the processing. Note that the end of the editing can be determined based on any condition such as a case where a notification indicating that the editing has ended is received from the client device 10 or a case where there is no response from the client device 10 for a predetermined time.

As described above, with the information processing system 1 according to the present embodiment, the source code can be edited in the server device 30 in response to an editing request from the client device 10. Since this editing can be shared by a plurality of users, a plurality of programmers can freely edit the source file of the same control program from different terminals at different timings. It is also possible to apply a lock such that the number of users who can perform editing at the same time is one, and in this case, it is also possible to reflect results edited by the respective programmers on the server device 30 so as not to conflict.

### Second Embodiment

Although it has been described that the source code is edited by any terminal at any timing in the first embodiment described above, the information processing system 1 may have a debugging function instead of such an editing function. Of course, the editing function of the first embodiment may be included, but the debugging function will be mainly described hereinafter.

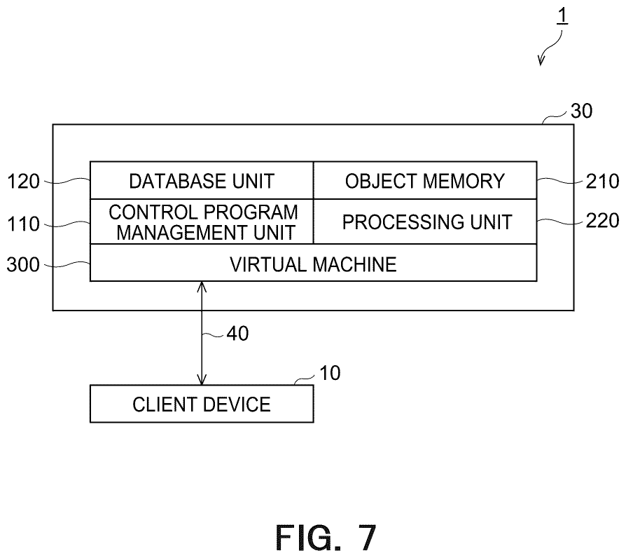

FIG. 7 is a diagram schematically illustrating an example of the information processing system 1 according to one embodiment. The server device 30 may construct the object memory 210 and the processing unit 220 of the control device 20 on the virtual machine 300 as a virtual environment.

The server device 30 may use an emulator or a simulator of the processing unit 220 to construct the processing unit 220 of the control device 20 in the virtual environment. The server device 30 can execute an object file generated from an edited control program in the virtual environment by using the simulator and the like. The server device 30 may construct a stub corresponding to a plant as necessary.

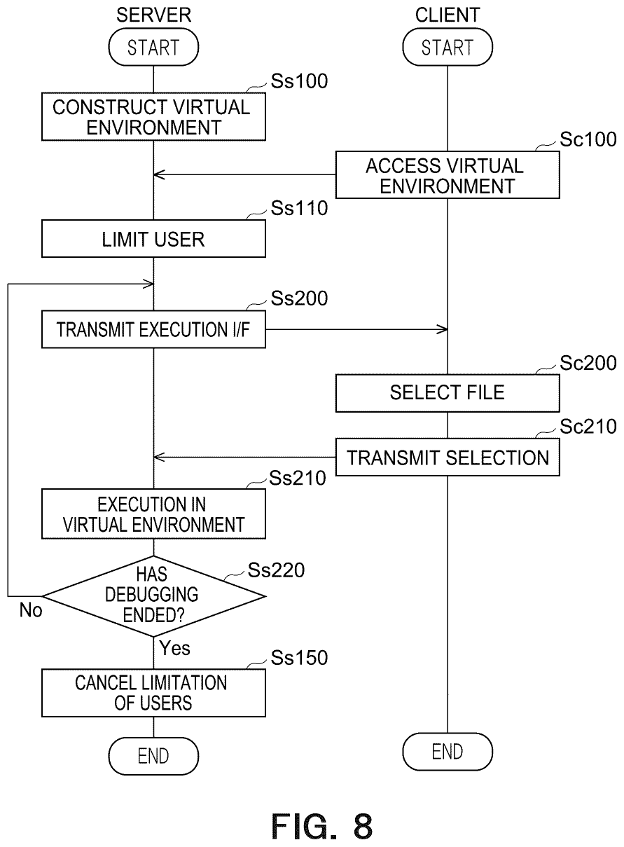

FIG. 8 is a flowchart illustrating an example of processing of the information processing system 1 according to the embodiment. Note that a process denoted by the same reference sign as that in FIG. 6 is a basically process in which the same processing is executed, and thus detailed description thereof will be omitted.

The server device 30 limits users permitted to perform debugging (Ss110), and thereafter, transmits an execution interface related to execution to the client device 10 (Ss200). The execution interface may be integrated with the editing interface described above, and in this case, a process similar to the process of Ss120 in FIG. 6 can be performed.

The client device 10 outputs the execution interface from the output device 140, and selects a file to be debugged (virtually executed) based on a request from a user (Sc200). The client device 10 transmits information on the selected file to the server device 30 (Sc210). Through this processing, a programmer can convert the control program into an execution file in the virtual environment and request the execution.

The server device 30 that has received the information on the selected file executes compilation of the file and generation of the object file in the control program management unit 110 of the virtual environment, and virtually downloads and executes the object file in the control device 20 of the virtual environment (Ss210). The server device 30 may appropriately transmit execution progress or an execution result to the client device 10, and the client device 10 may output the received execution progress and execution result via the output device 140.

The server device 30 continues debugging processing in a case where the debugging has not ended (Ss220: No) or cancels the limitation of the users (Ss150) in a case where the debugging has ended (Ss220: Yes), and ends the processing.

As described above, with the information processing system 1, it is possible to cause the file selected by the programmer to be executed in the virtual environment and to acquire the progress of execution in the simulator and the result of the execution. As a result, the user can virtually execute any file and confirm the action thereof.

Note that a mode in which not only debugging (program execution) but also editing can be executed in parallel may be adopted as described above. In this case, the processing of the client device 10 of FIG. 8 can be implemented by executing the processes of Sc110 and Sc120 of FIG. 6 at any timing after the timing at which the editing interface is received from the server device 30.

In addition, an example in which the simulator and the like are constructed on the same virtual machine has been described, but the construction of the simulator and the like is not limited thereto. For example, a simulator and the like of the control device 20 may be constructed on a virtual machine different from the virtual machine 300 in which the virtual client device 10 is constructed. In this case, there may be a plurality of the server devices 30, and the virtual machine in which the client device 10, the simulator, and the like are virtually constructed may be formed in each of the server devices 30.

According to the above two embodiments, it is possible to implement editing and debugging work of a control program by a plurality of programmers from any terminal at any timing.

### Third Embodiment

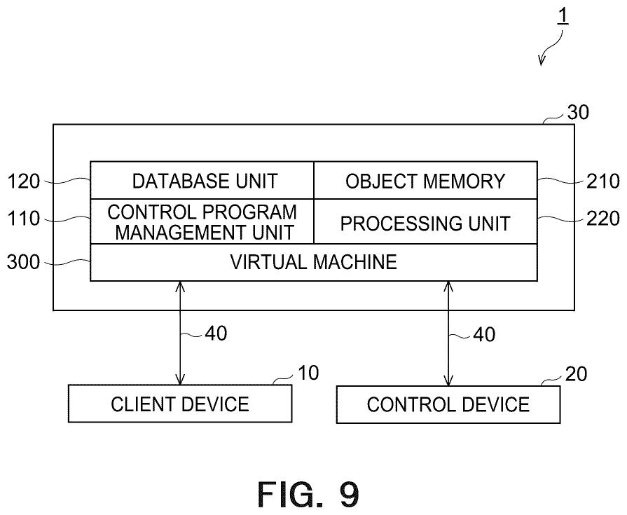

FIG. 9 is a diagram schematically illustrating an example of the information processing system 1 according to one embodiment. The information processing system 1 may adopt a mode in which transmission and reception of data are possible between the server device 30 and the control device 20 via the network 40.

In the mode illustrated in FIG. 9, debugging of an object file downloaded to the control device 20 at the current time has been described as described above, but the mode according to such a configuration is not limited thereto.

As another example, editing and debugging may be executed on a control program transmitted from the client device 10 or a control program stored in the server device 30 in a virtual environment, and an object file for which debugging has been completed may be downloaded to the control device 20 via the network 40.

By performing this processing, the object file debugged using a simulator and the like in the virtual environment can be appropriately downloaded to the control device 20, and the accuracy of plant control can be improved.

### Fourth Embodiment

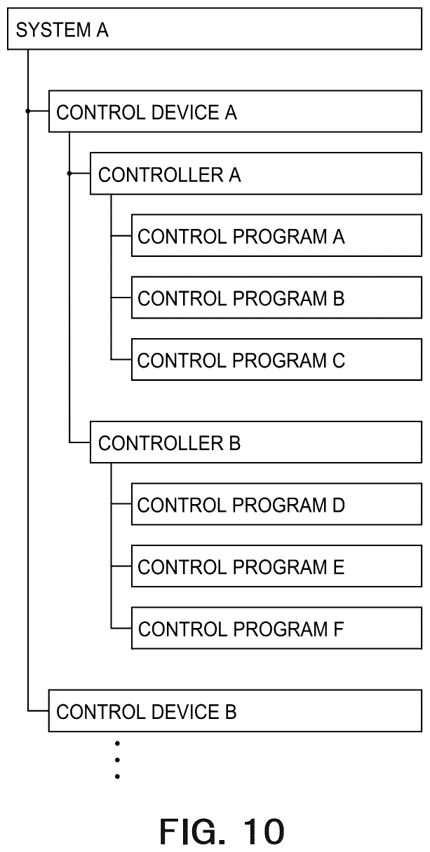

FIG. 10 is a diagram illustrating an example of construction of a system according to one embodiment. For example, a system A includes control devices A and B which are two control devices 20. The control device A includes a controller A and a controller B, and control programs in the respective controllers are deployed as illustrated in the drawing.

In the information processing system 1 according to the present disclosure, such a system configuration can be constructed in a virtual environment. For example, the server device 30 constructs the virtual control devices 20 corresponding to the control devices A and B in the virtual environment, and constructs an appropriate virtual network environment connecting these control devices.

In this manner, after the plurality of control devices 20 are constructed, it is possible to simulate whether or not the control devices 20 operate properly in cooperation.

This configuration can be achieved by implementing, in the virtual environment, compilation of the control programs, formation of object files, and downloading and execution of the control programs to the virtual control devices 20, which are basically similar to those in the above-described embodiments.

As described above, according to the present embodiment, it is also possible to simulate the operation of a virtually constructed control system in a virtual space and further implement editing and debugging work of the control programs based on a result of the simulation.

Note that items necessary for plant control, such as a library, a network, a protocol, a unit, a module, an I/O node, a memory array, and task management to be used, can be implemented in this virtual configuration of the control system, and debugging work can also be performed for these items.

Each of the information processing devices (the client device 10, the control device 20, and the server device 30) in each of the above-described embodiments can be achieved using a processing circuit (a processor or the like) and a storage circuit (a memory, a storage, or the like. As the processing circuit, a general-purpose processor may be used, or a dedicated processor such as an application specified integrated circuitry (ASIC) may be used at least partially. These configurations may be implemented as a general integrated circuitry (IC) or the like, or may be implemented by a rewritable circuit such as a field programable gate array (FPGA).

In information processing of the information processing devices in each of the above-described embodiments, a part or the whole of information processing achieved by software may be specifically implemented using a hardware device. In this case, a program or the like necessary for the information processing achieved by software may be stored in storage areas (non-transitory computer-readable media) of the client device 10 and the server device 30 (not illustrated), or may be stored in the object memory 210 of the control device 20. A processing circuit such as a processor can appropriately deploy the program stored in the storage area in each of the information processing devices, and can specifically implement information processing achieved by software. In addition, the program can be distributed, sold, or transferred by a non-transitory computer readable medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing system configured to create and debug a control program executed in a control device, the information processing system comprising:
at least one server device configured to:
operate in a cloud environment to which a plurality of client devices are connected via a network;
configure a virtual machine in the cloud environment;
virtually configure the control device as a virtual control device in the virtual machine;
compile the control program; and
execute the control program in the virtual control device; and
the plurality of client devices configured to:
transmit a request for compiling the control program in the virtual machine to the server device; and
transmit a request for executing content of the control program in the virtual control device to the server device.

2. The information processing system according to claim 1, wherein
the server device is configured to:
configure an editing interface of the control program in the virtual machine;
transmit the editing interface to the client devices;
edit the control program based on the request received from the client devices; and
compile the control program, and
the client devices are configured to
request the server device to edit the control program via the editing interface of the virtual machine.

3. The information processing system according to claim 1, wherein
the server device is configured to:
construct at least one of a hardware configuration of the control device, a network configuration, and other configurations of the control device in the virtual machine to construct an environment for executing the compiled control program; and
execute the control program in the constructed configuration.

4. The information processing system according to claim 2, wherein
the server device is configured to:
construct at least one of a hardware configuration of the control device, a network configuration, and other configurations of the control device in the virtual machine to construct an environment for executing the compiled control program; and
execute the control program in the constructed configuration.

5. The information processing system according to claim 1, wherein
the server device is configured to
transmit the compiled control program to the control device, and
the client devices are configured to
back up edited content in the virtual machine.

6. The information processing system according to claim 2, wherein
the server device is configured to
transmit the compiled control program to the control device, and
the client devices are configured to
back up edited content in the virtual machine.

7. The information processing system according to claim 1, wherein
the client devices construct remote desktops to access the virtual machine.

8. The information processing system according to claim 2, wherein
the client devices construct remote desktops to access the virtual machine.

9. An information processing system configured to create and debug a control program executed in a control device, the information processing system comprising:
at least one server device configured to:
operate in a cloud environment to which a plurality of client devices are connected via a network;
configure a virtual machine in the cloud environment;
configure an editing interface of the control program in the virtual machine;
transmit the editing interface to the client devices; and
edit the control program based on a request received from the client devices; and
the plurality of client devices configured to
request the server device to edit the control program via the editing interface of the virtual machine.
